(19) United States
(12) Patent Application Publication
(10) Pub. No.: US 2023/0215130 A1
(43) Pub. Date: Jul. 6, 2023

(54) IMAGE PROCESSING APPARATUS, IMAGE PROCESSING METHOD, PROGRAM, AND IMAGE PROJECTION METHOD

(71) Applicant: SONY GROUP CORPORATION, Tokyo (JP)

(72) Inventors: Ryutaro MINE, Tokyo (JP); Tomu TAHARA, Tokyo (JP)

(73) Assignee: SONY GROUP CORPORATION, Tokyo (JP)

(21) Appl. No.: 18/000,573

(22) PCT Filed: May 13, 2021
(86) PCT No.: PCT/JP2021/018201

§ 371 Date: Dec. 2, 2022

(30) Foreign Application Priority Data
Jun. 15, 2020 (JP) 2020-102784

(51) Int. Cl. G06V 10/56; G06T 7/90; G06V 10/74; H04N 1/60; H04N 5/74; H04N 9/69

(52) U.S. Cl. CPC G06V 10/56; G06T 7/90; G06V 10/761; H04N 1/6052; H04N 5/74; H04N 9/69; G06T 2207/10024

(57) ABSTRACT

An image processing apparatus generates, from a mixed image of projection images projected from a plurality of projection devices, separated images for respective pieces of color information, on the basis of a color model. For the color model, the pieces of color information of the projection images changed according to spectral characteristics of the projection devices and an image pickup device for acquiring the captured image and an attenuation coefficient are used as parameters, and a color separation processing section generates the separated images for the respective pieces of color information on the basis of the color model, by using parameters that minimize the difference between the color information of the captured image and color information estimated by the color model. The image processing apparatus becomes able to accurately separate projection images from the captured image of the mixed image including a plurality of projection images.

### TECHNICAL FIELD

The present technique relates to an image processing apparatus, an image processing method, a program, and an image projection method and makes it possible to separate projection images from a captured image of a mixed image including a plurality of projection images.

### BACKGROUND ART

In the past, one mixed image is displayed by combining projection images of a plurality of projection devices. In this case, the projection image is taken by using an image pickup device to acquire a positional relation of respective projection images, and a problem of mismatching of the images in the superimposition area of the projection images is solved.

In addition, in order to acquire positions of the projection images, it is necessary to have a pixel correspondence relation between the projection devices and the image pickup device, so that images for sensing called structured light are projected for image pickup, and search for the correspondence relation is made. For example, in PTL 1, when structured light beams are projected at the same time, the structured light beams are mixed with each other, and which projection device the pixel information of the captured projection image corresponds to cannot be determined, and thus by giving different color information, projection images of a plurality of projection devices is distinguished. Further, in PTL 2, projection images of a plurality of devices is distinguished by using a region that does not have overlapping spatially.

### CITATION LIST

### Patent Literature

[PTL 1]
JP 2012-047849A
[PTL 2]
JP 2015-056834A

### SUMMARY

### Technical Problem

Incidentally, in the case where the projected light beams are distinguished by using the color information as in PTL 1, if the projected color and the captured color do not agree with each other due to the colors of the screen and ambient light, the device specific spectral characteristics of the projection device and the image pickup device, and the like, a projection image different from the desired projection image may appear in a separation result, which may cause a decrease in sensing accuracy or a failure in sensing.

Further, in the case where a region that does not have overlapping spatially is used as in PTL 2, for example, there is a restriction on a pattern in which the projection images can be arranged without overlapping the markers, and a restriction so that the projection areas of the projectors must be arranged side by side in a fixed manner to some extent is needed in order to avoid the overlapping. Therefore, a wide range of projection image arrangements cannot be coped with, such as stacking projection in which a plurality of projection ranges is substantially entirely overlapped, and a degree of freedom of the arrangement is low. Further, since the markers are arranged so as to avoid overlapping in the projected light, a density of information that can be used for correction is reduced.

Therefore, an object of this technique is to provide an image processing apparatus, an image processing method, a program, and an image projection method capable of separating projection images from a captured image of a mixed image including a plurality of projection images.

### Solution to Problem

A first aspect of the present technique is an image processing apparatus including a color separation processing section that generates separated images on the basis of color information of a captured image obtained by capturing a mixed image of projection images given pieces of color information different from each other and projected from a plurality of projection devices and a color model indicating a relation between the color information of the captured image and the pieces of color information of the projection images and color information of a background, each of the separated images being generated for each of the pieces of color information.

In this technique, a color separation processing section generates separated images on the basis of a color information of the captured image obtained by capturing the mixed image of the projection images of structured light, for example, which are given pieces of color information different from each other and are projected from a plurality of projection devices, and a color model indicating a relation between the color information of the captured image the pieces of color information of the projection images and the color information of a background, with each of the separated images generated for each of the pieces of color information. For the color model, the pieces of color information of the projection images changed according to the spectral characteristics of the projection devices and the image pickup device that acquires the captured image and an attenuation coefficient that indicates an attenuation that occurs in the mixed image captured by the image pickup device are used as parameters, and the color separation processing section generates separated images for the respective pieces of color information on the basis of the color model by using parameters that minimize the difference between the color information of the captured image and the color information estimated by the color model.

Further, the image pickup device that captures the mixed image is a non-fixed viewpoint type, and in the case where gamma correction is performed by the image pickup device, the color separation processing section generates separated images with use of the captured image that has undergone degamma processing. Also, the pieces of color information different from each other are set such that the inner product of color vectors corresponding to the pieces of color information is minimized. Also, the projection images and the captured image are images in which saturation has not occurred.

Further, an image correcting section for correcting the projection images to be projected from the projection devices is provided, and color proofing of the projection images is performed using the color information given to the separated images. In addition, a corresponding point detecting section for detecting corresponding points between the separated images for respective pieces of color information generated by the color separation processing section is provided, and the image correcting section corrects the projection images by using geometric correction information for matching with each other the respective corresponding points of separated images, which are detected by the corresponding point detecting section.

In addition, a plurality of projection devices is divided into groups each having a predetermined number of projection devices, so that at least one projection device in each group is included in another group, and projection images are given pieces of color information different from each other and projected in each group, the color separation processing section generates separated images for each group, the corresponding point detecting section detects the corresponding points for each group, and the image correcting section corrects the projection images by using the geometric correction information that matches with each other the respective corresponding points of the separated images detected by the corresponding point detecting section for each group.

A second aspect of the present technique is an image processing method including generating separated images in a color separation processing section from a captured image obtained by capturing a mixed image of projection images given pieces of color information different from each other and projected from a plurality of projection devices, on the basis of a color model including the pieces of color information of the projection images and color information of a background color, each of the separated images being generated for each of the pieces of color information.

A third aspect of the present technique is a program for causing a computer to execute a procedure for separating projection images from a captured image obtained by capturing a mixed image of projection images, the program causing the computer to execute a step of acquiring a captured image obtained by capturing the mixed image of the projection images given pieces of color information different from each other and projected from a plurality of projection devices, and a step of generating separated images each of which is generated for each of the pieces of color information, from the captured image, on the basis of a color model including the pieces of color information of the projection images and color information of a background color.

It should be noted that the program of the present technique is one that can be provided by a storage medium or a communication medium in a computer-readable format to a general-purpose computer capable of executing various program codes, that is, a storage medium such as an optical disk, a magnetic disk, or a semiconductor memory, or a communication medium such as a network. By providing such a program in a computer-readable format, processing according to the program can be realized on the computer.

A fourth aspect of the present technique is an image projection method including generating separated images in a color separation processing section from a captured image obtained by capturing a mixed image of projection images given pieces of color information different from each other and projected from a plurality of projection devices, on the basis of a color model including the pieces of color information of the projection images and color information of a background color, each of the separated images being generated for each of the pieces of color information, detecting, by a corresponding point detecting section, corresponding points between the separated images, each of which is for each of the pieces of color information, generated by a color separation processing section, and correcting the projection images to be projected from the plurality of projection devices by an image correcting section using geometric correction information for matching with each other the respective corresponding points of the separated images detected by a corresponding point detecting section.

### BRIEF DESCRIPTION OF DRAWINGS

FIG. 1 is a diagram illustrating a configuration of an image projection system.

FIG. 2 is a diagram illustrating the configuration of an embodiment.

FIG. 3 is a flowchart illustrating an operation of the embodiment.

FIG. 4 is a diagram illustrating a spectral sensitivity of an image pickup device.

FIG. 5 is a diagram illustrating a color change of a captured image with respect to a projection image.

FIG. 6 is a diagram illustrating a captured image that changes depending on an environment.

FIG. 7 depicts diagrams illustrating sensing patterns and a projection state on a screen.

FIG. 8 is a flowchart illustrating a parameter estimation operation.

FIG. 9 is a diagram illustrating separated images.

FIG. 10 is a diagram illustrating an example of the parameter estimation operation.

FIG. 11 is a diagram illustrating sensing patterns (structured light) projected from projection devices.

### DESCRIPTION OF EMBODIMENTS

Hereinafter, modes for carrying out the present technique will be described. Incidentally, the description will be given in the following order.

1. Regarding image projection system

2. Configuration of embodiment

3. Operation of embodiment
3-1. Generating operation for separated images
3-2. Other operations of embodiment
3-2-1. Regarding sensing pattern
3-2-2. Regarding gamma characteristic
3-2-3. Regarding case where there are three or more projection devices
3-2-4. Regarding color information to be given
3-2-5. Regarding color proofing
3-2-6. Regarding projection conditions and image capturing conditions

### 1. Regarding Image Projection System

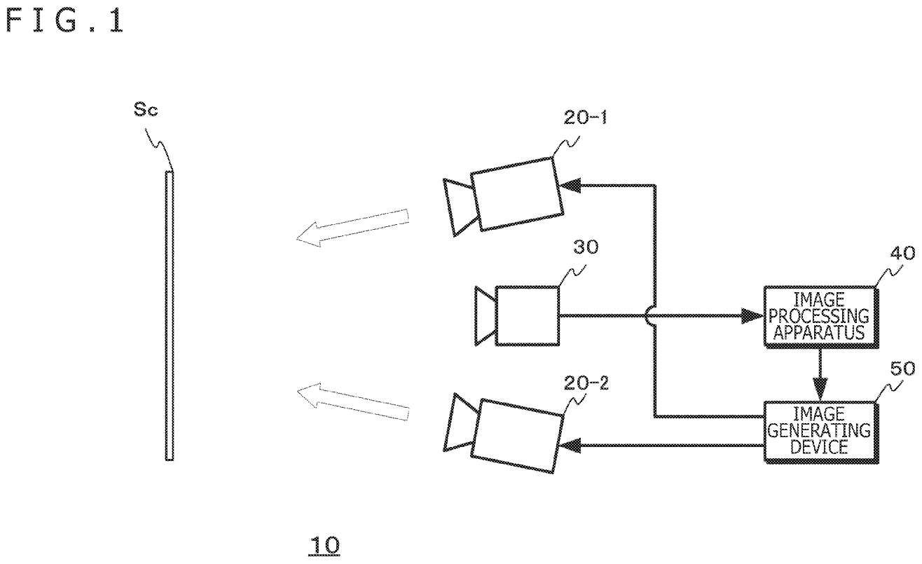

FIG. 1 illustrates a configuration of an image projection system using an image processing apparatus of the present technique. Note that FIG. 1 illustrates a case where two projection devices are used.

An image projection system 10 has projection devices 20-1 and 20-2 that project images on a screen Sc, an image pickup device 30 that captures images of the screen Sc from a viewpoint not fixed (non-fixed viewpoint), an image processing apparatus 40 that separates projection images from the captured image acquired by the image pickup device 30, and an image generating device 50 that outputs an image signal indicating an image to be projected on the screen Sc to the projection devices 20-1 and 20-2. The image pickup device 30, the image processing apparatus 40, and the image generating device 50 may be provided independently, and these devices may be integrated or only some of the devices (for example, the image processing apparatus 40 and the image generating device 50) may be integrated to be provided. Further, the image generating device 50 or the image processing apparatus 40 and the image generating device 50 may be integrated with any of the projection devices 20-1 and 20-2 to be provided.

### 2. Configuration of Embodiment

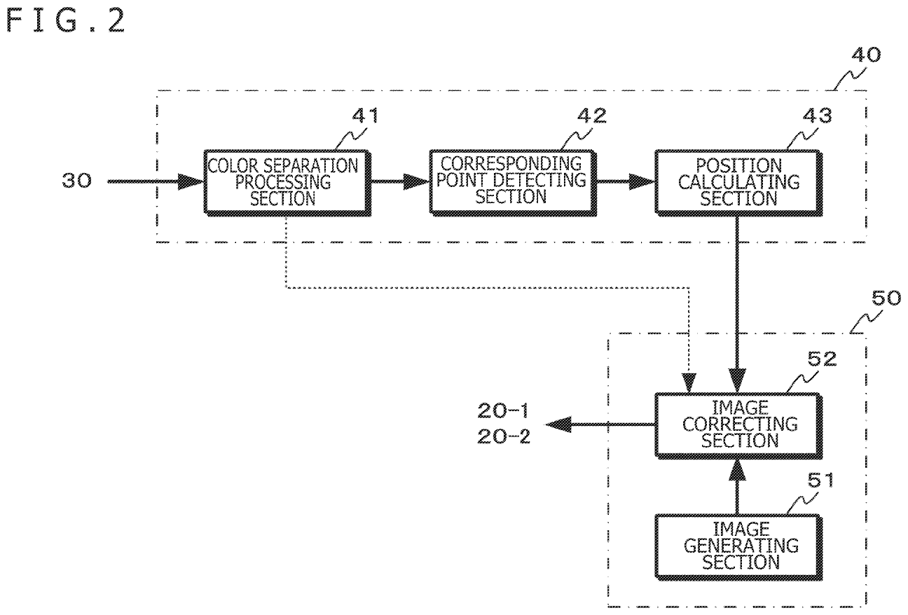

FIG. 2 illustrates the configuration of the embodiment, and the image processing apparatus 40 includes a color separation processing section 41, a corresponding point detecting section 42, and a position calculating section 43.

For example, at the time of calibration of the image projection system, projection images such as sensing patterns (structured light) are projected on the screen Sc by the projection devices 20-1 and 20-2, and the sensing patterns have been given pieces of different color information for respective projection devices. The image pickup device 30 captures images of the screen Sc on which the sensing patterns are projected, from a non-fixed viewpoint, and acquires a captured image representing a mixed image of the first sensing pattern projected by the projection device 20-1 and the second sensing pattern projected by the projection device 20-2.

The color separation processing section 41 generates separated images for respective pieces of color information given to the sensing patterns on the basis of the color information of the captured image acquired by the image pickup device 30 and a color model indicating a relation between the color information of the captured image and the color information of the projection images and the background. Incidentally, the details of generating the separated images for the respective pieces of color information will be described later. The color separation processing section 41 outputs the generated separated images to the corresponding point detecting section 42.

The corresponding point detecting section 42 detects the corresponding points between the separated images for the respective pieces of color information, and outputs the corresponding point information indicating the detection result to the position calculating section 43.

The position calculating section 43 calculates a position correction amount for causing the display positions of the corresponding points detected by the corresponding point detecting section 42 to agree with each other. For example, the position calculating section 43 calculates the position correction amount for causing the display position of the corresponding point of the separated image of the color information given to the second sensing pattern to agree with the corresponding point of the separated image of the basis when regarding the separated image of the color information given to the first sensing pattern as the basis. The position calculating section 43 outputs the calculated position correction amount to the image generating device 50.

The image generating device 50 has an image generating section 51 and an image correcting section 52. The image generating section 51 generates image signals of the projection images. For example, when the image projection system is calibrated, the image generating section 51 generates a first sensing pattern as a projection image to be projected from the projection device 20-1 and a second sensing pattern as a projection image to be projected from the projection device 20-2. Further, the image generating section 51 gives color information to the first sensing pattern and gives color information different from that of the first sensing pattern to the second sensing pattern. After calibrating the image projection system, the image generating section 51 generates an image meeting the request of the user or the like as a projection image to be projected from the projection device 20-1 and an image meeting the request of the user or the like as a projection image to be projected from the projection device 20-2. The image generating section 51 outputs image signals representing the generated images to the image correcting section 52.

For example, at the start of calibration of the image projection system, the image correcting section 52 outputs the image signal of the first sensing pattern to be projected from the projection device 20-1 to the projection device 20-1, and outputs the image signal of the second sensing pattern to be projected from the projection device 20-2 to the projection device 20-2. Further, the image correcting section 52 uses the position correction amount calculated by the position calculating section 43 of the image processing apparatus 40 as geometric correction information, and performs geometric correction of the projection images to match the projection image to be projected from the projection device 20-1 with the projection image projected from the projection device 20-2 by using the geometric correction information during and after the calibration process of the image projection system. For example, in the case where the position correction amount calculated by the position calculating section 43 of the image processing apparatus 40 is based on the first sensing pattern, the image correcting section 52 performs geometric correction on the basis of geometric correction information for the projection image to be projected from the projection device 20-2. The image correcting section 52 outputs, to the projection device 20-1, the first sensing pattern to be projected from the projection device 20-1 during the calibration process, and the image signal of the image according to a request from the user or the like to be projected from the projection device 20-1 after the calibration. Further, the image correcting section 52 performs geometric correction of the first sensing pattern to be projected from the projection device 20-2 during the calibration process, and geometric correction of the image according to the request from the user or the like to be projected from the projection device 20-2 after the calibration, and outputs the image signal after the geometric correction to the projection device 20-2.

Incidentally, the image correcting section 52 may be provided in the projection device instead of the image generating device 50. For example, in the case where the position correction amount calculated by the position calculating section 43 of the image processing apparatus 40 is based on the first sensing pattern, the image correcting section 52 may be provided in the projection device 20-2.

### 3. Operation of Embodiment

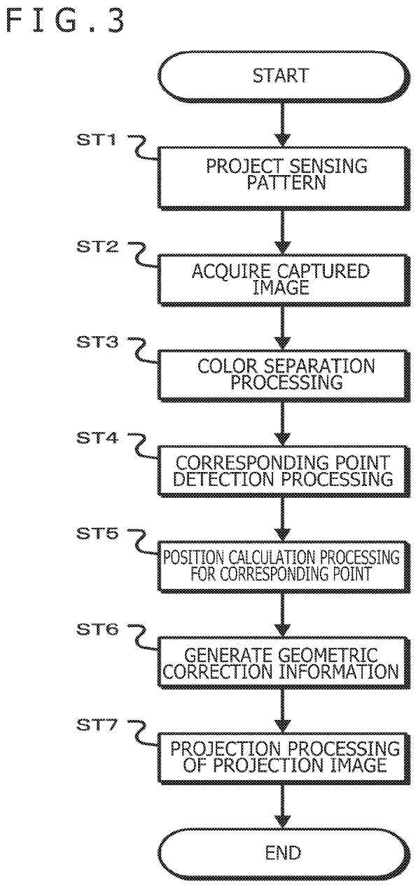

FIG. 3 is a flowchart illustrating the operation of an embodiment. In step ST1, the image projection system projects sensing patterns. In order to calibrate the image projection system, the projection devices 20-1 and 20-2 of the image projection system 10 project, on the screen Sc, the first sensing pattern and the second sensing pattern to which pieces of color information different from each other are given, and proceed to step ST2.

In step ST2, the image projection system acquires a captured image. The image pickup device 30 of the image projection system 10 captures a mixed image of the first sensing pattern projected from the projection device 20-1 and the second sensing pattern projected from the projection device 20-2 on the screen Sc from a non-fixed viewpoint, and acquires a captured image exhibiting a mixed image, then proceeding to step ST3.

In step ST3, the image projection system performs color separation processing. The color separation processing section 41 in the image processing apparatus 40 of the image projection system 10 generates a first separated image of the color information given to the first sensing pattern and a first separated image of the color information given to the second sensing pattern on the basis of the color information given to the first and second sensing patterns and the color model indicating a relation between the color information of the captured image, and the color information of the projection images and the background, and proceeds to step ST4.

In step ST4, the image projection system performs the corresponding point detection processing. The corresponding point detecting section 42 in the image processing apparatus 40 detects corresponding points corresponding to each other in the first separated image and the second separated image generated by performing the color separation processing in step ST3. For the detection of the corresponding points, known techniques described in JP 2000-348175A, JP 2018-011302A, and the like may be used. The corresponding point detecting section 42 detects the corresponding points and proceeds to step ST5.

In step ST5, the image projection system performs the position calculation processing for the corresponding points. The position calculating section 43 in the image processing apparatus 40 calculates the display positions of the corresponding points detected in step ST4 and proceeds to step ST6.

In step ST6, the image projection system generates geometric correction information. Based on the display positions of the corresponding points calculated in step ST5, the image correcting section 52 in the image generating device 50 generates the geometric correction information by calculating, for each corresponding point, the position correction amount that causes the display positions of the corresponding points to be the same, and finishes calibrating the image projection system. After that, in the case of projecting projection images such as video content in response to a request from the user or the like, the process proceeds to step ST7.

In step ST7, the image projection system performs projection processing of the projection image. The image generating device 50 of the image projection system 10 generates image signals of projection images according to a request from a user or the like in the image generating section 51. Further, the image correcting section 52 performs geometric correction on the projection images generated by the image generating section 51 on the basis of the geometric correction information, and outputs the image signals of the projection images after the geometric correction to the projection devices 20-1 and 20-2, so that the projection images from the projection devices 20-1 and 20-2 are projected onto the screen Sc without causing mismatching.

### 3-1. Generating Operation for Separated Images

Next, the operation of generating the separated images will be described. In the separated image generating operation, separated images for the respective pieces of color information are generated on the basis of the color information of the captured image obtained by capturing a mixed image of the projection images given pieces of color information different from each other and projected from a plurality of projection devices and a color model indicating the relation between the color information of the captured image and color information of the projection images and the background.

For the color model, color information of projection images that change according to the spectral characteristics of the projection devices and the image pickup device that acquires the captured image, an attenuation coefficient that indicates the attenuation that occurs in the mixed image captured by the image pickup device, and color information of the background are used as parameters, and the color separation processing section generates separated images for the respective pieces of color information on the basis of the color model by using parameters that minimize the difference between the color information of the captured image and the color information estimated by the color model.

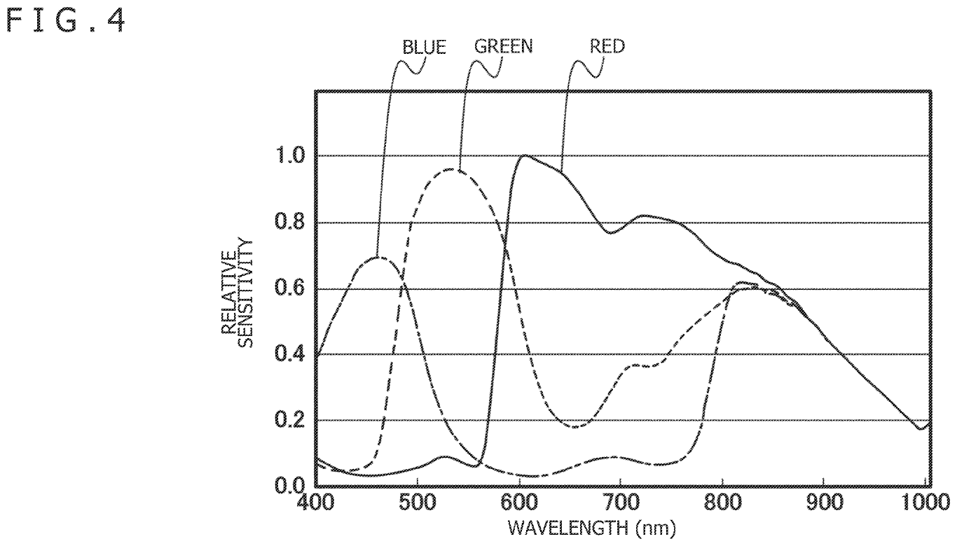

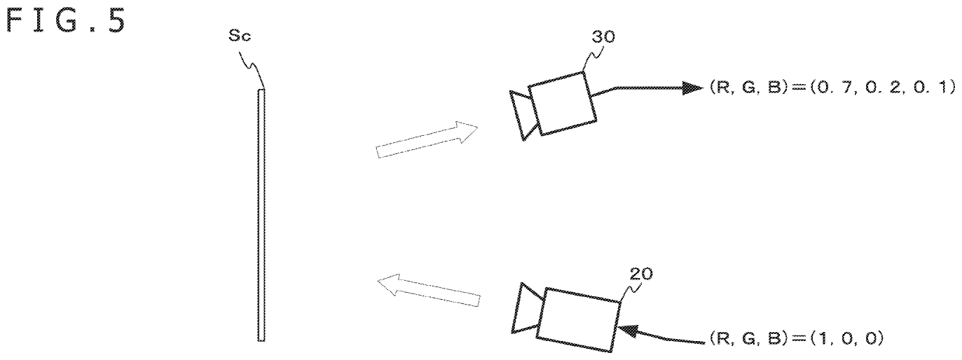

In the color separation processing, in the case where the spectral characteristics of a projection device 20 and the image pickup device 30 are different, the separation performance may deteriorate. FIG. 4 illustrates the spectral sensitivity of the image pickup device. The image pickup device 30 has sensitivity in a wavelength range of three primary colors (red R, green G, blue B), and the sensitivities of the respective colors partially overlap, for example, green and blue sensitivity exist in the wavelength (610 to 750 nm) of red. Therefore, there are cases where the color of the projection image may change in the captured image. FIG. 5 illustrates the color change of the captured image with respect to the projection image. The projection image input to the projection device 20 is, for example, “(R, G, B)=(1, 0, 0).” In this case, since the image pickup device 30 has the sensitivity of green and blue with respect to the wavelength of red, the acquired captured image may become “(R, G, B)=(0.7, 0.2, 0.1),” for example.

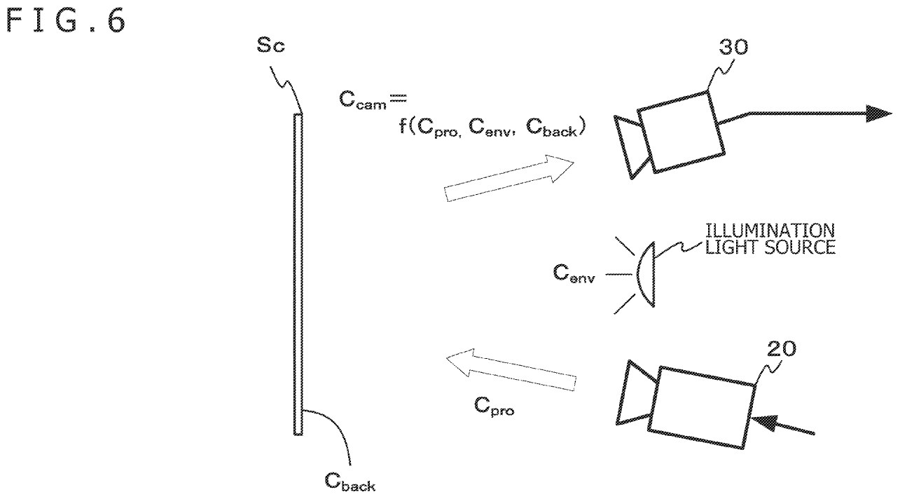

Moreover, in the case where the environment is taken into consideration, the captured image changes according to the environment. FIG. 6 illustrates a captured image that changes depending on the environment. For example, in the case where the projection image has color Cpro, the ambient light from the illumination light source has color Cenv, and a projection surface of the screen Sc has color Cback, the color Ccam of the projection image observed by the image pickup device 30 has a value expressed by the function of equation (1).

Ccam=f(Cpro,Cenv,Cback) (1)

As described above, there are cases where the projection image in the captured image acquired by the image pickup device 30 may have a color different from that of the projection image input to the projection device 20 due to the spectral characteristics of the projection device 20 and the image pickup device 30. Further, the projection image observed by the image pickup device 30 is affected not only by the color Cpro of the projected projection image, but also by the color Cenv of the ambient light and the color Cback of the projection surface of the screen Sc. Therefore, the color separation processing section 41 of the image processing apparatus 40 performs, in order to separate the mixed images with high accuracy, color separation processing by using the color information of the captured image obtained by capturing the mixed image of the projection images given pieces of color information different from each other and projected from the projection devices 20-1 and 20-2, and a color model that indicates the relation between the color information of the captured image and the color information of the projection images and the background. Note that, for ease of description, influence of gamma characteristics in projection and image pickup are not considered in the color model. Further, it is assumed that the projection devices 20-1 and 20-2 have the additivity of the projected light.

The color separation processing section 41 separates the mixed image by using the color model and generates separated images. Here, assuming that the color input to the projection device has a pixel value P (=Pr, Pg, Pb), the color transformation matrix of (3×3) based on the spectral characteristics of the image pickup device 30 is Tcam, and the color transformation matrix of (3×3) based on the spectral characteristics of the projection device is Tpro, and the background color including the ambient light color and the screen color has a pixel value BC (=Br, Bg, Bb), a pixel value CP (=Cr, Cg, Cb) of the captured image can be expressed as equation (2).

[Math. 1]

CP=T_{cam}(TₚᵣₒP+BC) (2)

Further, the projection image projected from the projection device onto the screen Sc is attenuated due to an incident angle of the projected light on the screen Sc, a distance to the screen Sc, a reflectance of the projection surface of the screen Sc, and the like. Therefore, the attenuation coefficient α of the projection image is used for the color model, and the projection image captured by the image pickup device 30 is set as the pixel value (αP). Further, assuming that the input color of the projection device in this case has a pixel value (P′=Pr, Pg, Pb) and the background color has a pixel value (BC′=Br′, Bg′, Bb′), the color model indicated in equation (2) becomes the color model indicated in equation (3).

[Math. 2]

CP=T_{cam}(TₚᵣₒPα+BL)=P′α+BC′ (3)

Next, the case where in order to calibrate the image projection system, a separated image exhibiting a sensing pattern is generated with high accuracy for each sensing pattern from the captured image obtained by capturing a mixed image of the sensing patterns given pieces of color information different from each other and projected from the projection devices 20-1 and 20-2 will be described.

In this case, assuming that the input color of the projection device 20-1 has a pixel value P1′, the attenuation coefficient of the projection image projected by the projection device 20-1 is “α1,” and the input color of the projection device 20-2 has a pixel value P2′, the attenuation coefficient of the projection image projected by the projection device 20-2 is “α2,” the color model is that illustrated in equation (4). Incidentally, the pixel value P1′ and the pixel value P2′ have additivity of the projected light, and have a relation of equation (5).

[Math. 3]

CP=P₁′α1+P₂′+BC′ (4)

∥P₁′∥=∥P₂′∥ (5)

Incidentally, equation (4) is a color model for one corresponding pixel in the projection image and the captured image, and the color separation processing section 41 applies the color model to the entire captured image. For example, the captured image has a horizontal pixel number QH and a vertical pixel number QV. Further, the color information at the pixel position (x, y) in the captured image is set to the pixel value CPx,y, and the attenuation coefficient at the pixel position (x, y) is set to “α1x,y” and “α2x,y.” Further, the attenuation coefficient vectors indicating the attenuation coefficient at each position on the screen are set to av1 and av2.

The color separation processing section 41 uses the pixel value CPx,y and estimates the parameters (pixel values) “P1′, P2′, and BC,” and the parameters (subtrahend coefficients) “α1 and α2” that minimize evaluation value EV indicated in equation (6) and satisfy the condition of expression (7).

[Math. 4]

EV=Σ_{y}^{QH}Σₓ^{QV}(CP_{x,y}−(P₁′α1_{x,y}+P₂′α2_{x,y}+BC′)) (6)

s·t·α1_{x,y},α2_{x,y}≥0,CP_{x,y},P₁′,P₂′,BC′≥0 (7)

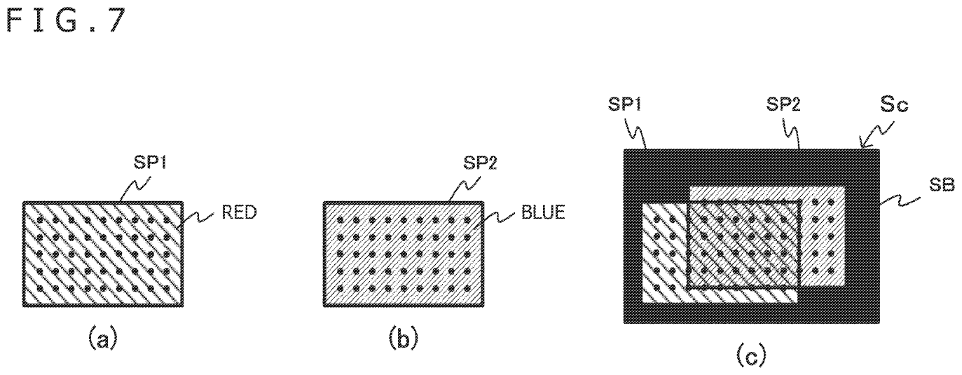

FIG. 7 illustrates the sensing patterns and the projection state on the screen. Part (a) of FIG. 7 illustrates a first sensing pattern SP1 projected from the projection device 20-1, and part (b) of FIG. 7 illustrates a second sensing pattern SP2 projected from the projection device 20-2. The first sensing pattern is a pattern in which black dots are provided in a red rectangular region, for example, and the second sensing pattern is a pattern in which black dots are provided in a blue rectangular region, for example. Part (c) of FIG. 7 illustrates a state in which the first sensing pattern SP1 and the second sensing pattern SP2 are projected on the screen Sc, and the area that corresponds to neither the first sensing pattern SP1 nor the second sensing pattern SP2 is a background area SB. It should be noted that it is detected in advance which is the pixel position (x, y) from among the background area, the region to which the color of the sensing pattern is added, and the region of the black dots of the sensing pattern. For example, if the first sensing pattern and the second sensing pattern are projected individually, it is clear which region the pixel position (x, y) corresponds to.

When the pixel position (x, y) is the pixel position of the sensing pattern, the color separation processing section 41 uses the color information of the corresponding regions in the sensing patterns for the pixel values P1′ and P2′. Further, when the pixel position (x, y) is the pixel position in the background area, the pixel values P1′ and P2′ are set to “0.”

The color separation processing section 41 performs the calculation indicated in equation (8) to generate the pixel value CP1 of the separated image representing the first sensing pattern projected by the projection device 20-1 on the basis of the color model. Further, the color separation processing section 41 performs the calculation indicated in equation (9) to generate the pixel value CP2 of the separated image representing the second sensing pattern projected by the projection device 20-2 on the basis of the color model.

[Math. 5]

CP₁=P₁′αv1+BC′ (8)

CP₂=P₂′αv2+BC′ (9)

Next, parameter estimation will be described. The color separation processing section 41 divides the estimation of the parameters so as to be able to estimate the parameters easily and repeats the process of estimating other parameters by using the estimation results so as to estimate the optimum values of the parameters that minimize the difference of the color information of the captured image and color information estimated by the color model. For example, the color separation processing section 41 performs the process of estimating the parameters indicating the color information and the process of estimating the parameters indicating the attenuation coefficient separately, and repeats the process in which the estimation result of one is used for the other so as to use the converged estimation result as the optimum values of the parameters.

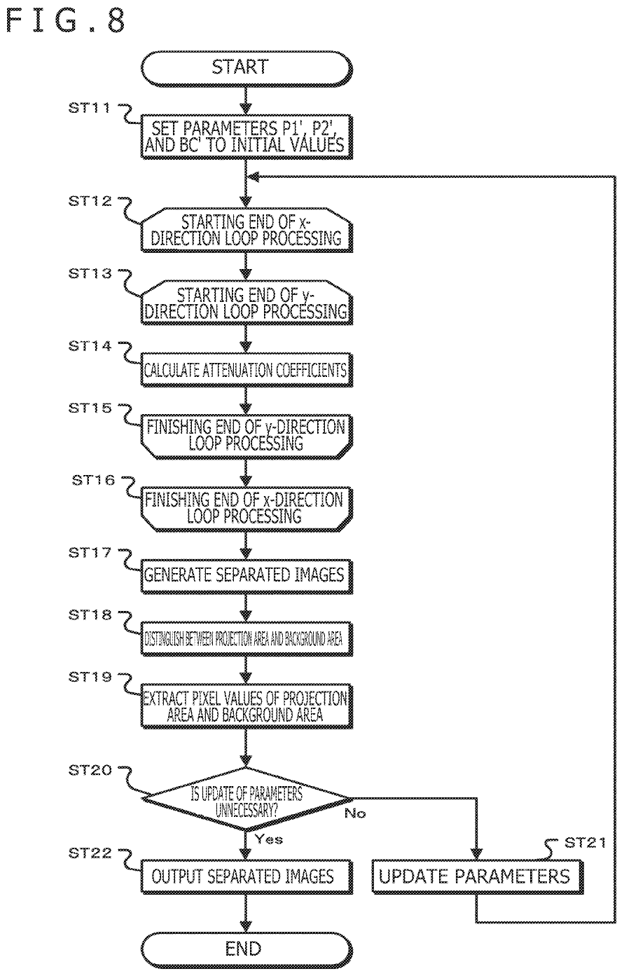

FIG. 8 is a flowchart illustrating the parameter estimation operation. In step ST11, the color separation processing section sets parameters P1′, P2′, and BC′ to the initial values. The color separation processing section 41 sets the parameters P1′, P2′, and BC′ as initial values when estimating the attenuation coefficient. In the spectral characteristics of a general projection device or an image pickup device, the color information has no significant change between the input and output. Therefore, by setting the initial values of the parameters P1′ and P2′ to the pixel values reflecting the spectral characteristics, the convergence can be accelerated. For example, as initial values in consideration of spectral characteristics, there are used the parameter P1′ detected by projecting a sensing pattern to which color information is given, from the projection device 20-1 and capturing the image thereof, and the parameter P2′ detected by projecting a sensing pattern to which color information is given, from the projection device 20-2 and capturing the image thereof. Further, in the case of using a projection device, it is common to use a white screen under dark room conditions, and therefore, when the initial value of the parameter BC′ is set to black, convergence can be accelerated. Still further, as the initial value in consideration of the spectral characteristics, also when the pixel value detected by capturing the image of the screen on which the sensing pattern is not projected from the projection devices 20-1 and 20-2 is used as the initial value of the parameter BC′, the convergence can be accelerated. The color separation processing section 41 sets the parameters P1′, P2′, and BC′ as the initial values, and proceeds to step ST12.

Step ST12 is a starting end of an x-direction loop processing. The color separation processing section 41 starts a process of sequentially moving the pixel position for calculating the attenuation coefficient pixel by pixel in the x-direction of the captured image and proceeds to step ST13.

Step ST13 is a starting end of a y-direction loop processing. The color separation processing section 41 starts a process of sequentially moving the pixel position for calculating the attenuation coefficient pixel by pixel in the y-direction of the captured image and proceeds to step ST14.

In step ST14, the color separation processing section calculates the attenuation coefficient. The color separation processing section 41 calculates the attenuation coefficients α1x,y and α2x,y at the pixel position (x, y) on the basis of equation (3), by using the set parameters P1′, P2′, and BC′ and the pixel value CP of the captured image, and proceeds to step ST15.

Step ST15 is a finishing end of the y-direction loop processing. The color separation processing section 41 proceeds to step ST16 in the case of having calculated the attenuation coefficient for each pixel position in the y-direction, and sequentially moves the pixel position in the y-direction to calculate the attenuation coefficient by repeating the processes of steps ST13 to ST15 in the case where the calculation of the attenuation coefficient is not completed.

Step ST16 is a finishing end of the x-direction loop processing. The color separation processing section 41 proceeds to step ST17 in the case of having calculated the attenuation coefficient for each pixel position not only in the y-direction but also in the x-direction, and repetitively performs the processing of steps ST12 to ST16 in the case of not having completed the calculation of the attenuation coefficient, thereby calculating the attenuation coefficient of each pixel position in the captured image by sequentially moving the pixel position not only in the y-direction but also in the x-direction.

In step ST17, the color separation processing section generates separated images. The color separation processing section 41 makes calculation by equations (8) and (9) by using the set parameters P1′, P2′, and BC′ and the attenuation coefficient vectors av1 and av2 calculated in the processing of steps ST12 to ST16, to generate a separated image exhibiting the first sensing pattern projected from the projection device 20-1 and a separated image exhibiting the second sensing pattern projected from the projection device 20-2, and the process proceeds to step ST18.

In step ST18, the color separation processing section distinguishes between a projection area and the background area. The color separation processing section 41 distinguishes the projection area and the background area of each of the separated images generated in step ST17 on the basis of the pixel values of the separated images and the like. For example, the color separation processing section 41 uses the color information given to the sensing pattern to determine a region of similar color information to be the projection area and determines a region other than the projection area to be the background area. The color separation processing section 41 distinguishes between the projection area and the background area, and proceeds to step ST19.

In step ST19, the color separation processing section extracts the pixel values of the projection area and the background area. The color separation processing section 41 extracts pixel values from the projection area and the background area determined in step ST18. Note that, in the case where the pixel value extracted from the projection area and the pixel value extracted from the background area have variation, the color separation processing section 41 may use a statistical value calculated by statistical processing of the pixel value, such as an average value, a median value, or a mode value, as the extracted pixel value. The color separation processing section 41 extracts the pixel values PE1′ and PE2′ in the projection area and the pixel values BCE′ in the background area, and proceeds to step ST20.

In step ST20, the color separation processing section determines whether or not the parameter update is unnecessary. The color separation processing section 41 calculates the difference between the parameters P1′, P2′, and BC′ used for calculating the attenuation coefficients α1 and α2 and the pixel values PE1′, PE2′, and BEC′ calculated in step ST19, respectively, and determines that the update is necessary in the case where any of the calculated differences is larger than the preset threshold value, and then proceeds to step ST21. Further, the color separation processing section 41 determines that in the case where the calculated differences are equal to or less than the preset threshold values, the update is unnecessary, that is, the parameters have converged to the optimum values, and proceeds to step ST22.

In step ST21, the color separation processing section updates the parameters. The color separation processing section 41 updates the parameters whose calculated difference is larger than the preset threshold value and sets the pixel values extracted in step ST19 as the parameters to be used for calculating the attenuation coefficients α1 and α2, and returns to step ST12.

When proceeding from step ST20 to step ST22, the color separation processing section outputs separated images. Since the estimation results have converged, the color separation processing section 41 outputs the separated images generated in step ST17 to the corresponding point detecting section 42.

When such processing is performed by the color separation processing section 41, the separated image representing the first sensing pattern and the separated image representing the second sensing pattern are generated from the captured image obtained by capturing a mixed image of the first sensing pattern and the second sensing pattern with the parameters set as the optimum values in the color model, and therefore, the sensing pattern can be separated more accurately than in the conventional case.

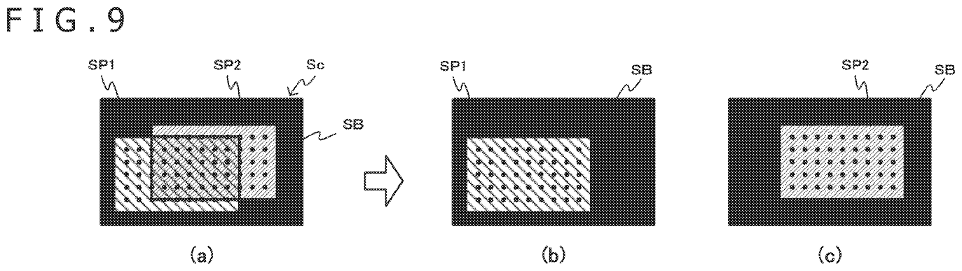

FIG. 9 illustrates separated images. Part (a) of FIG. 9 illustrates a state in which the first sensing pattern SP1 and the second sensing pattern SP2 are projected on the screen Sc, and the area that corresponds to neither the first sensing pattern SP1 nor the second sensing pattern SP2 is the background area SB. The color separation processing section 41 performs the processing illustrated in FIG. 8, to be able to generate a separated image representing the first sensing pattern SP1 as illustrated in part (b) of FIG. 9 and a separated image representing the second sensing pattern SP2 as illustrated in part (c) of FIG. 9 from a captured image obtained by capturing images of the first sensing pattern SP1 and the second sensing pattern SP2 projected on the screen Sc as illustrated in part (a) of FIG. 9.

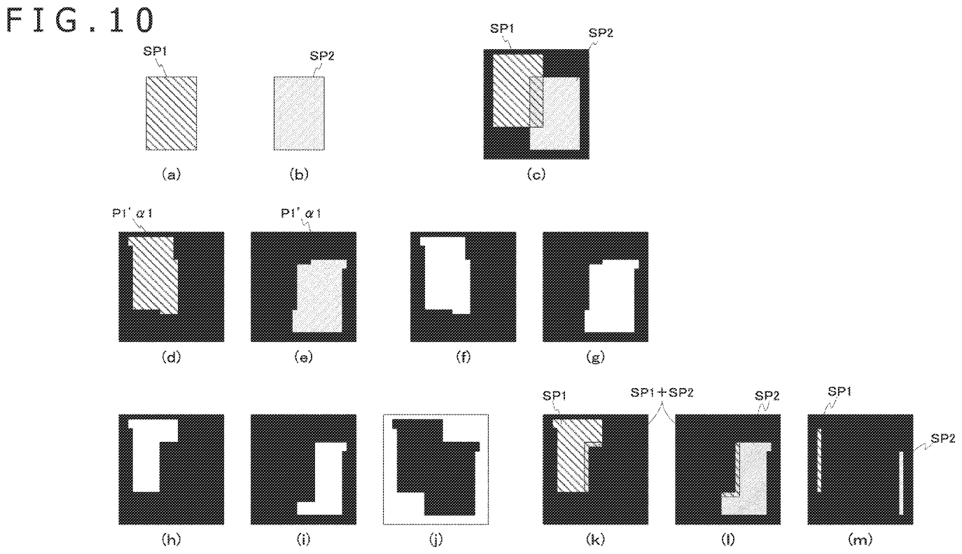

FIG. 10 is a diagram illustrating an example of parameter estimation operation. Note that, in order to facilitate understanding of the operation, it is assumed that the first sensing pattern SP1 illustrated in part (a) of FIG. 10 and the second sensing pattern SP2 illustrated in part (b) of FIG. 10 are projected onto the screen Sc, and the image illustrated in part (c) of FIG. 10 is captured by the image pickup device 30.

In order to obtain the color information in the background area and the projection area for each projection device, the color separation processing section 41 binarizes the image to determine the projection area and finds the projection area for each projection device on the basis of the difference from the projection area other than its own area. The background area is an area that does not belong to any projection area.

Parts (d) and (e) of FIG. 10 illustrate the separated images generated in step ST17, and the region of the first sensing pattern has the pixel value “P1′α1,” and the region of the second sensing pattern has the pixel value “P2′α2.” Note that part (f) of FIG. 10 illustrates a mask indicating the region of the pixel value “P1′α1” in the separated image, and part (g) of FIG. 10 illustrates a mask indicating the region of the pixel value “P2′α2” in the separated image.

The color separation processing section 41 determines the projection area in order to obtain the color information in the projection area of the first sensing pattern. To be specific, by applying the mask illustrated in part (f) of FIG. 10 to the captured image illustrated in part (c) of FIG. 10 and binarizing the image extracted, with use of the color information given to the first sensing pattern, the projection area of the first sensing pattern illustrated in part (h) of FIG. 10 is determined.

Further, the color separation processing section 41 determines the projection area in order to obtain the color information in the projection area of the second sensing pattern. To be specific, by applying the mask illustrated in part (f) of FIG. 10 to the captured image illustrated in part (c) of FIG. 10 and binarizing the image extracted, with use of the color information given to the second sensing pattern, the projection area of the second sensing pattern illustrated in part (i) of FIG. 10 is determined.

Further, the color separation processing section 41 determines the background area in order to obtain the color information in the background area. To be specific, the region masked in both parts (f) and (g) of FIG. 10 (the region illustrated in black) is set as the background area as illustrated in part (j) of FIG. 10.

Part (k) of FIG. 10 illustrates an image of the projection area of the first sensing pattern determined by applying the mask illustrated in part (h) of FIG. 10 to the captured image illustrated in part (c) of FIG. 10, and the image of the projection area of the first sensing pattern includes not only the first sensing pattern SP1 but also a part of the second sensing pattern SP2.

Part (1) of FIG. 10 illustrates an image of the projection area of the second sensing pattern determined by applying the mask illustrated in part (i) of FIG. 10 to the captured image illustrated in part (c) of FIG. 10, and the image in the projection area of the second sensing pattern includes not only the second sensing pattern SP2 but also a part of the first sensing pattern SP1.

Part (m) of FIG. 10 illustrates an image of the background area determined by applying the mask illustrated in part (j) of FIG. 10 to the captured image illustrated in part (c) of FIG. 10, and the image of the background area includes a part of the first sensing pattern SP1 and a part of the second sensing pattern SP2.

In such a way, when the region to be determined includes another region, it is determined that the parameters need to be updated in step ST20, and the parameters to be used for calculating the attenuation coefficients α1 and α2 are updated as illustrated in step ST21. Further, when the processes of steps ST12 to ST21 are repeated, the other regions included in the region to be determined gradually decrease, and when the region to be determined does not include other regions, the parameters converge, and separated images in which the first sensing pattern SP1 and the second sensing pattern SP2 are accurately separated can be obtained.

In such a way, since the separated images are generated by using the converged parameters, accurate separated images can be obtained even in the case where the separation residue is generated by the conventional separation method.

Further, when estimating the parameters P1′, P2′, and BC′ from the color information of the projected light from each projection device and the background color, the color separation processing section 41 uses the distribution of respective pieces of extracted color information in a three-dimensional color space (for example, an RGB color space). For example, the parameters P1′ and P2′ are estimated by regression lines and principal component analysis regarding the color distribution of the projected light. For the parameter BC′, a statistical value of pixel values in the background area, such as an average value, a median value, and a mode value is used. Further, in the case where the captured image of the background has been acquired, the color information thereof may be used.

It is to be noted that in the above operation, an example is illustrated in which the estimation of the optimum values of the parameters P1′, P2′, and BC′ and the calculation of the attenuation coefficients α1 and α2 are performed alternately until the parameters P1′, P2′, and BC′ converge, but other methods may be used to estimate the optimum values for the parameters P1′, P2′, and BC′. For example, the nonlinear minimization problem of equation (6) may be directly solved to obtain pixel values P1′α1+BC′ and P2′α2+BC′ of the separated images.

As described above, according to the present technique, each projection image can be accurately separated from the captured image acquired by the image pickup device capturing a mixed image of the projection images simultaneously projected on the screen from a plurality of projection devices. In addition, after detecting the corresponding points of the separated projection images, the spatial positions of the projection images are obtained from the detected corresponding point information, and thus the image can be corrected such that the mismatching in the area where the projection images are superimposed can be accurately eliminated.

Further, since it is possible to accurately make division into the separated images and generate geometric correction information by using the image captured by the image pickup device with a non-fixed viewpoint, it is not necessary to fix the image pickup device at a predetermined position as in the conventional case, so that the image projection system can be easily calibrated.

### 3-2. Other Operations of Embodiment

### 3-2-1. Regarding Sensing Pattern

The sensing pattern is not limited to the image including dots as illustrated in FIG. 7 and may be used by giving pieces of different color information to a gray code pattern or a checker pattern that does not have color information for respective projection devices.

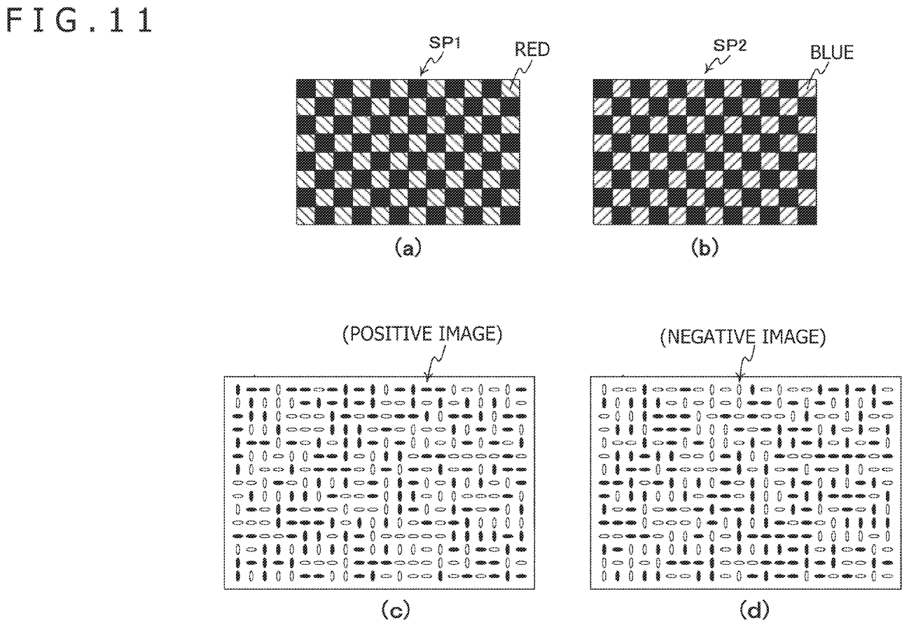

FIG. 11 illustrates sensing patterns (structured light) projected from the projection devices, and the sensing patterns may be checker patterns to which pieces of different color information are given as illustrated in parts (a) and (b) of FIG. 11. Further, color information may be given to the patterns in parts (c) and (d) of FIG. 11 illustrated in PCT Patent Publication WO 2017/104447 “Image processing apparatus and method, data, and recording medium” for the usage.

In the case where a sensing pattern is generated by giving color information to a pattern that has no color information, the color information to be given is generated using the pixel values of the pattern that has no color information. For example, in the case where the color information P=(Pr, Pg, Pb) of the three primary colors is generated, when the pixel to be given color information in the pattern having no color information has the pixel value Y, the color information PY of the pixel value Y is set to satisfy PY=(Pr(Y), Pg(Y), Pb(Y)). Note that Pr(Y) indicates that the red component has the pixel value Y, and Pg (Y) indicates that the green component has the pixel value Y, and Pb (Y) indicates that the blue component has the pixel value Y. In such a way, the process of generating color information by using the pixel values of the pixels to be given color information is performed individually on the pixels of the pattern having no color information as the pixels to be given color information, and by giving the generated color information to the pattern having no color information, a sensing pattern having color information can be generated.

### 3-2-2. Regarding Gamma Characteristic

In the above-described <3-1. Operation of embodiment>, the case where the influence of the gamma characteristic is not taken into consideration has been described, but the color separation processing can be performed in a similar manner even in the case where the influence of the gamma characteristic is taken into consideration. For example, in the case where the image pickup device 30 performs gamma correction to generate a captured image, the color separation processing section 41 performs degamma processing on the color information C(x, y) of the captured image to be used in equation (6) for conversion to linear color space information and uses the color information that has undergone degamma processing. By using the color information subjected to the degamma processing in such a way, the projection image can be accurately separated as in the above-described embodiment.

### 3-2-3. Regarding Case where there are Three or More Projection Devices

In the above-described <3-1. Operation of embodiment>, the case where two projection devices are used has been described, but even in the case where there are three or more projection devices, the projection images for respective projection devices can be accurately separated by extending equation (6). Further, in the case where the number of projection devices is four or more, if the color information is the information of the three-dimensional color space, a plurality of optimum solutions of the attenuation coefficient satisfy equation (6), and the color separation processing cannot be performed correctly. Therefore, it is necessary to use the continuity with the adjacent pixel color and the information of the projection image as the constraint conditions so that a plurality of optimum solutions do not exist.

Further, in the image projection system, groups each having a predetermined number (for example, two or three) of projection devices are set for a plurality of projection devices such that at least one projection device in each group is included in another group. In addition, pieces of different color information are given within each group. In such a way, groups are formed and each group is subjected to <3-1. Operation of embodiment> described above, a positional relation of the projection images from a plurality of projection devices becomes clear on the basis of the corresponding points of the separated images detected for each group, and geometric correction information that matches with each other the respective corresponding points of the separated images detected for each group can be generated. Therefore, even in the case where a large number of projection devices are used, the image can be corrected such that the mismatching in the region where the projection images are superimposed can be accurately eliminated by using the geometric correction information.

### 3-2-4. Regarding Color Information to be Given

When the above-mentioned parameters P1′ and P2′ do not have a relation of “P1′=P2′,” the projection images projected by respective projection devices can be separated from the mixed image. However, in the case of estimating a region from the distribution of a three-dimensional color space, as the difference in distribution becomes larger, the region can be estimated more accurately. Therefore, the color information to be given to the projection images may be selected such that the inner product of the color vectors corresponding to the parameter P1′ and the parameter P2′ is minimized. For example, in the case of an RGB color space, when two colors are selected from red (R, G, B)=(1, 0, 0), green (R, G, B)=(0, 1, 0), and blue (R, G, B)=(0, 0, 1), it becomes easy to separate the projection images projected by respective projection devices from the mixed image.

### 3-2-5. Regarding Color Proofing

Incidentally, in the projection device, there are cases where technique such as color proofing may be used to project an image with correct color expression. In this method, images are projected from projection devices in various different colors, and the input signal value is determined such that the color when the projected image is captured is the correct color in a real space. Therefore, in the present technique, if color proofing is performed by using the color information given to the sensing pattern to be projected, the geometric correction of the image can be performed such that the mismatching in the area where the projection images are superimposed can be accurately eliminated, and in addition, the projection image can be projected in the correct color. In this case, if the color information to be given is set to cover the three primary colors by switching the color combination each time the image pickup device captures the projection image, color proofing can be performed with high accuracy. As described above, since the color proofing can be performed by using the color information given to the projected sensing pattern, it is not necessary to perform the color proofing in advance, and the image projection system can be efficiently calibrated.

### 3-2-6. Regarding Projection Conditions and Image Capturing Conditions

In addition, in the color model of the present technique, since the projected light is expressed by the scalar multiple of the vector, in the case where the captured image is saturated positively or negatively (when white crushing or black crushing occurs), the color balance of the projected light is lost, and the separation accuracy is reduced in the saturated region. Therefore, the projection conditions and the image capturing conditions are set such that the pixel values of the projection images and the captured image have a wide range of values without causing saturation. For example, it is effective to adjust the projection images such that the ranges of the input images are as wide as possible but not saturated, with reference to the histogram of the pixel value for each color in the captured image.

The series of processes described in the specification can be executed by hardware, software, or a composite configuration of both. In the case of executing processing by software, the program that records the processing sequence is installed in the memory in the computer embedded in the dedicated hardware and executed. Alternatively, the program can be installed and executed in a general-purpose computer capable of executing various types of processing.

For example, the program can be recorded in advance in a hard disk, an SSD (Solid State Drive), or a ROM (Read Only Memory) as a recording medium. Alternatively, the program can be temporarily or permanently stored (recorded) on a removable recording medium such as a flexible disc, a CD-ROM (Compact Disc Read Only Memory), an MO (Magneto optical) disc, a DVD (Digital Versatile Disc), a BD (Blu-Ray Disc (registered trademark)), a magnetic disc, and a semiconductor memory card. Such a removable recording medium can be provided as generally-called package software.

Further, the program may be transferred from the download site to the computer wirelessly or by wire via a network such as a LAN (Local Area Network) or the Internet in addition to being installed in the computer from the removable recording medium. The computer can receive the program transferred in such a way and install the program in a recording medium such as a built-in hard disk.

It should be noted that the effects described in the present specification are merely examples and the invention is not limited thereto, and there may be additional effects not described. In addition, the present technique should not be construed as being limited to the embodiments of the technique described above. The embodiment of this technique discloses the present technique in the form of an example, and it is obvious that a person skilled in the art can modify or substitute the embodiment without departing from the gist of the present technique. That is, in order to determine the gist of this technique, the claims should be taken into consideration.

In addition, the image processing apparatus of the present technique can also have the following configurations.

(1)

An image processing apparatus including:

1 a color separation processing section that generates separated images on the basis of color information of a captured image obtained by capturing a mixed image of projection images given pieces of color information different from each other and projected from a plurality of projection devices and a color model indicating a relation between the color information of the captured image and the pieces of color information of the projection images and color information of a background, each of the separated images being generated for each of the pieces of color information.

(2)

The image processing apparatus according to (1), in which,

for the color model, pieces of color information of the projection images changed according to spectral characteristics of the projection devices and an image pickup device that acquires the captured image and an attenuation coefficient indicating attenuation that occurs in the mixed image captured by the image pickup device are used as parameters.

(3)

The image processing apparatus according to (2), in which

the color separation processing section generates the separated images, each of which is for each of the pieces of color information, on the basis of the color model by using the parameters that minimize a difference between the color information of the captured image and color information estimated by the color model.

(4)

The image processing apparatus according to any one of (1) to (3), in which

the projected projection images given the pieces of color information include images of structured light.

(5)

The image processing apparatus according to any one of (1) to (4), in which

the color separation processing section uses the captured image that has undergone degamma processing in a case where an image pickup device that captures the mixed image performs gamma correction.

(6)

The image processing apparatus according to any one of (1) to (5), in which

the pieces of color information different from each other are set such that an inner product of color vectors corresponding to the pieces of color information is minimized.

(7)

The image processing apparatus according to any one of (1) to (6), in which

the projection images and the captured image include images in which saturation has not occurred.

(8)

The image processing apparatus according to any one of (1) to (7), in which

the captured image includes an image acquired by an image pickup device with a non-fixed viewpoint.

(9)

The image processing apparatus according to any one of (1) to (8), further including:

an image correcting section that corrects the projection images to be projected from the projection devices.

(10)

The image processing apparatus according to (9), in which

the image correcting section performs color proofing of the projection images by using the pieces color information given to the separated images.

(11)

The image processing apparatus according to (9), further including:

a corresponding point detecting section for detecting corresponding points between the separated images, each of which is for each of the pieces of color information, generated by the color separation processing section, in which

the image correcting section corrects the projection images by using geometric correction information for matching with each other the respective corresponding points of the separated images detected by the corresponding point detecting section.

(12)

The image processing apparatus according to (11), in which

the plurality of projection devices is divided into groups each having a predetermined number of projection devices, such that at least one projection device in each of the groups is included in another of the groups, and the projection images are given the pieces of color information different from each other and projected in each of the groups,

the color separation processing section generates the separated images for each of the groups,

the corresponding point detecting section detects the corresponding points for each of the groups, and the image correcting section corrects the projection images by using the geometric correction information for matching with each other the respective corresponding points of the separated images detected by the corresponding point detecting section for each of the groups.

### REFERENCE SIGNS LIST

10: Image projection system
20, 20-1, 20-2: Projection device
30: Image pickup device
40: Image processing apparatus
41: Color separation processing section
42: Corresponding point detecting section
43: Position calculating section
50: Image generating device
51: Image generating section
52: Image correcting section

What is claimed is:

1. An image processing apparatus, comprising:
a color separation processing section that generates separated images on a basis of color information of a captured image obtained by capturing a mixed image of projection images given pieces of color information different from each other and projected from a plurality of projection devices and a color model indicating a relation between the color information of the captured image and the pieces of color information of the projection images and color information of a background, each of the separated images being generated for each of the pieces of color information.

2. The image processing apparatus according to claim 1, wherein,
for the color model, pieces of color information of the projection images changed according to spectral characteristics of the projection devices and an image pickup device that acquires the captured image and an attenuation coefficient indicating attenuation that occurs in the mixed image captured by the image pickup device are used as parameters.

3. The image processing apparatus according to claim 2, wherein
the color separation processing section generates the separated images, each of which is for each of the pieces of color information, on a basis of the color model by using the parameters that minimize a difference between the color information of the captured image and color information estimated by the color model.

4. The image processing apparatus according to claim 1, wherein
the projected projection images given the pieces of color information include images of structured light.

5. The image processing apparatus according to claim 1, wherein
the color separation processing section uses the captured image that has undergone degamma processing in a case where an image pickup device that captures the mixed image performs gamma correction.

6. The image processing apparatus according to claim 1, wherein
the pieces of color information different from each other are set such that an inner product of color vectors corresponding to the pieces of color information is minimized.

7. The image processing apparatus according to claim 1, wherein
the projection images and the captured image include images in which saturation has not occurred.

8. The image processing apparatus according to claim 1, wherein
the captured image includes an image acquired by an image pickup device with a non-fixed viewpoint.

9. The image processing apparatus according to claim 1, further comprising:
an image correcting section that corrects the projection images to be projected from the projection devices.

10. The image processing apparatus according to claim 9, wherein
the image correcting section performs color proofing of the projection images by using the pieces color information given to the separated images.

11. The image processing apparatus according to claim 9, further comprising:
a corresponding point detecting section for detecting corresponding points between the separated images, each of which is for each of the pieces of color information, generated by the color separation processing section, wherein
the image correcting section corrects the projection images by using geometric correction information for matching with each other the respective corresponding points of the separated images detected by the corresponding point detecting section.

12. The image processing apparatus according to claim 11, wherein
the plurality of projection devices is divided into groups each having a predetermined number of projection devices, such that at least one projection device in each of the groups is included in another of the groups, and the projection images are given the pieces of color information different from each other and projected in each of the groups,
the color separation processing section generates the separated images for each of the groups,
the corresponding point detecting section detects the corresponding points for each of the groups, and
the image correcting section corrects the projection images by using the geometric correction information for matching with each other the respective corresponding points of the separated images detected by the corresponding point detecting section for each of the groups.

13. An image processing method, comprising:
generating separated images in a color separation processing section from a captured image obtained by capturing a mixed image of projection images given pieces of color information different from each other and projected from a plurality of projection devices, on a basis of a color model including the pieces of color information of the projection images and color information of a background color, each of the separated images being generated for each of the pieces of color information.

14. A program for causing a computer to execute a procedure for separating projection images from a captured image obtained by capturing a mixed image of projection images, the program causing the computer to execute:
a step of acquiring a captured image obtained by capturing the mixed image of the projection images given pieces of color information different from each other and projected from a plurality of projection devices; and
a step of generating separated images each of which is generated for each of the pieces of color information, from the captured image, on a basis of a color model including the pieces of color information of the projection images and color information of a background color.

15. An image projection method, comprising:
generating separated images in a color separation processing section from a captured image obtained by capturing a mixed image of projection images given pieces of color information different from each other and projected from a plurality of projection devices, on a basis of a color model including the pieces of color information of the projection images and color information of a background color, each of the separated images being generated for each of the pieces of color information;
detecting, by a corresponding point detecting section, corresponding points between the separated images, each of which is for each of the pieces of color information, generated by a color separation processing section; and
correcting the projection images to be projected from the plurality of projection devices by an image correcting section using geometric correction information for matching with each other the respective corresponding points of the separated images detected by a corresponding point detecting section.
